(19) United States
(12) Patent Application Publication
(10) Pub. No.: US 2004/0064499 A1
(43) Pub. Date: Apr. 1, 2004

(54) Method and system for active knowledge management

(76) Inventor: Kasra Kasravi, West Bloomfield, MI (US)

Correspondence Address: BAKER BOTTS L.L.P., 2001 ROSS AVENUE, SUITE 600, DALLAS, TX, 75201-2980, US

(21) Appl. No.: 10/259,177

(22) Filed: Sep. 26, 2002

(51) Int. Cl. G06F 15/16

(52) U.S. Cl. 709/202

(57) ABSTRACT

According to one embodiment of the invention, a network of computers for active knowledge management includes a plurality of event agents operable to monitor for an event, capture the attributes of the event, and announce the event. The network also includes a plurality of knowledge agents operable to examine a knowledge base, broadcast characteristics of the knowledge base, and interface with the knowledge base to extract knowledge in response to a request from a target agent, and a plurality of target agents operable to listen for broadcasted events and in response, travel to one of the knowledge agents, request knowledge related to the event, receive the requested knowledge, and deliver the received knowledge to a computer associated with the target agent.

### TECHNICAL FIELD OF THE INVENTION

This invention relates generally to knowledge management and more particularly to a method and system for active knowledge management.

### BACKGROUND OF THE INVENTION

The value of effective management of knowledge has been known for a very long time. In recent years, various knowledge management applications and tools have been developed to capitalize on knowledge. These tools have assumed many forms, such as search engines, web pages, computer-based training, push technology, groupware, document management, and text-mining. These tools help the user of the application to better capture, organize, index, and access knowledge. The knowledge in these tools can be in multiple forms, such as electronic documents, presentations, e-mails, databases, formulae, computer code, object libraries, images and video.

A common scenario with these existing approaches of knowledge management is that the user must initiate the search for knowledge. This can be challenging, time consuming, tedious, and prone to errors due to omissions or judgment.

### SUMMARY OF THE INVENTION

According to one embodiment of the invention, a network of computers for active knowledge management includes a plurality of event agents operable to monitor for an event, capture the attributes of the event, and announce the event. The network also includes a plurality of knowledge agents operable to examine a knowledge base, broadcast characteristics of the knowledge base, and interface with the knowledge base to extract knowledge in response to a request from a target agent, and a plurality of target agents operable to listen for broadcasted events and in response, travel to one of the knowledge agents, request knowledge related to the event, receive the requested knowledge, and deliver the received knowledge to a computer associated with the target agent.

Some embodiments of the invention provide numerous technical advantages. Some embodiments may benefit from some, none, or all of these advantages. For example, according to one embodiment of the invention, an active knowledge management system is provided that actively seeks information that may be relevant to a particular target entity at an appropriate time. In particular, relevant information is provided to the relevant people at the relevant time with the correct level of detail. Doing so provides more efficient knowledge management, allowing an underlying target entity to spend time analyzing only important information rather than spending time obtaining the important information.

Other technical advantages may be readily ascertained by one of skill in the art.

### BRIEF DESCRIPTION OF THE DRAWINGS

Reference is now made to the following description taken in conjunction with the accompanying drawings, wherein like reference numbers represent like parts, in which:

FIG. 1A illustrates a conceptual drawing of an active knowledge management system according to the teachings of the invention;

FIG. 1B illustrates one example implementation of the active knowledge management system of FIG. 1A;

FIG. 1C illustrates details of one of the computers of FIG. 1B;

FIG. 2A is a block diagram illustrating example details of a knowledge entity model according to the teachings of the invention;

FIG. 2B is a block diagram illustrating example details of an event entity model according to the teachings of the invention;

FIG. 2C is a block diagram illustrating example details of a target entity model according to the teachings of the invention;

FIG. 3A is a state diagram illustrating the operation of various agents in actively acquiring knowledge according to the teachings of the invention;

FIG. 3B is a flowchart illustrating operation of a knowledge agent according to the teachings of the invention;

FIG. 3C is a block diagram illustrating operation of an event agent according to the teachings of the invention; and

FIG. 3D is a flowchart illustrating operation of a target agent according to the teachings of the invention.

### DETAILED DESCRIPTION OF THE INVENTION

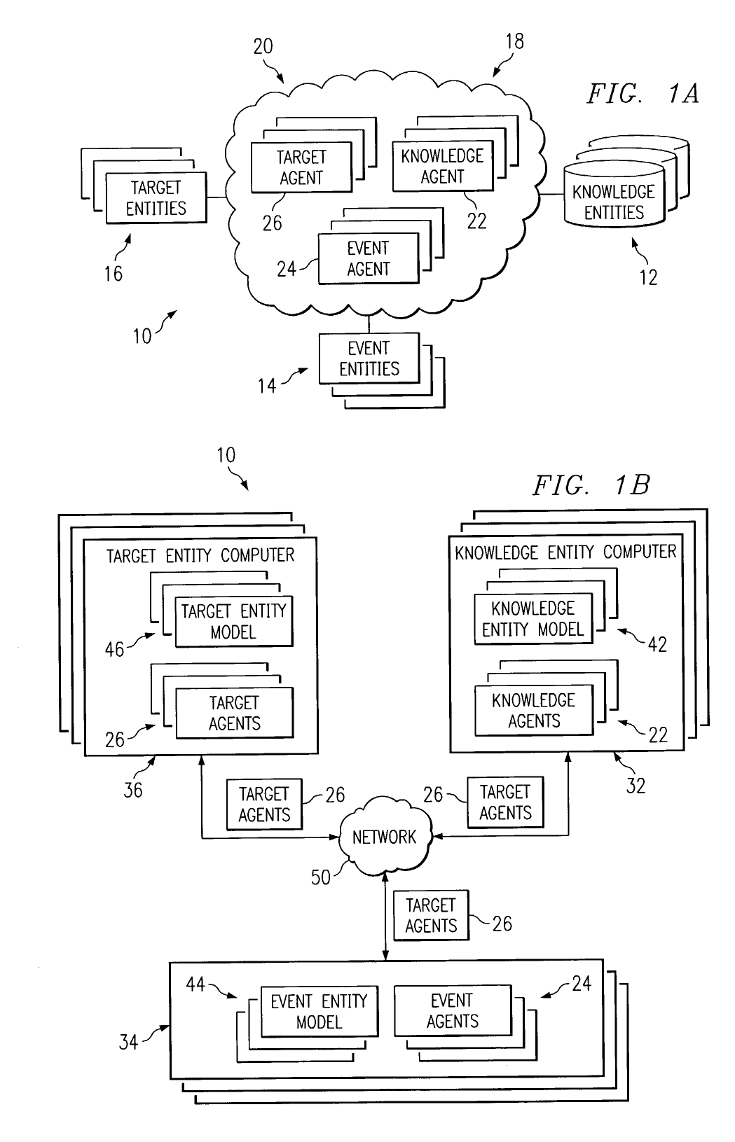

Embodiments of the invention are best understood by referring to FIGS. 1A through 3D of the drawings, like numerals being used for like and corresponding parts of the various drawings.

FIG. 1A illustrates a conceptual drawing of an active knowledge management system 10 according to the teachings of the invention. Active knowledge management system 10 includes one or more knowledge entities 12, one or more event entities 14, and one or more target entities 16. Associated with entities 12, 14, and 16 are agents. These agents include one or more knowledge agents 22, one or more event agents 24 and one or more target agents 26. These agents 20 may initially reside on the same computer as the associated entity or may reside elsewhere. In addition, these agents may be stationary, or travel to other locations to perform their functions; thus agents 20 are illustrated within a network cloud 18 of system 10.

Although active knowledge management system 10 could reside entirely within a local area network, it is contemplated that, for better operation, knowledge entities 12, event entities 14, and target entities 16 will be widely dispersed, and that communications facilitated by the various agents 20 may be effected through communication across a wide area network, such as the Internet, consisting of homogeneous or heterogeneous devices and protocols.

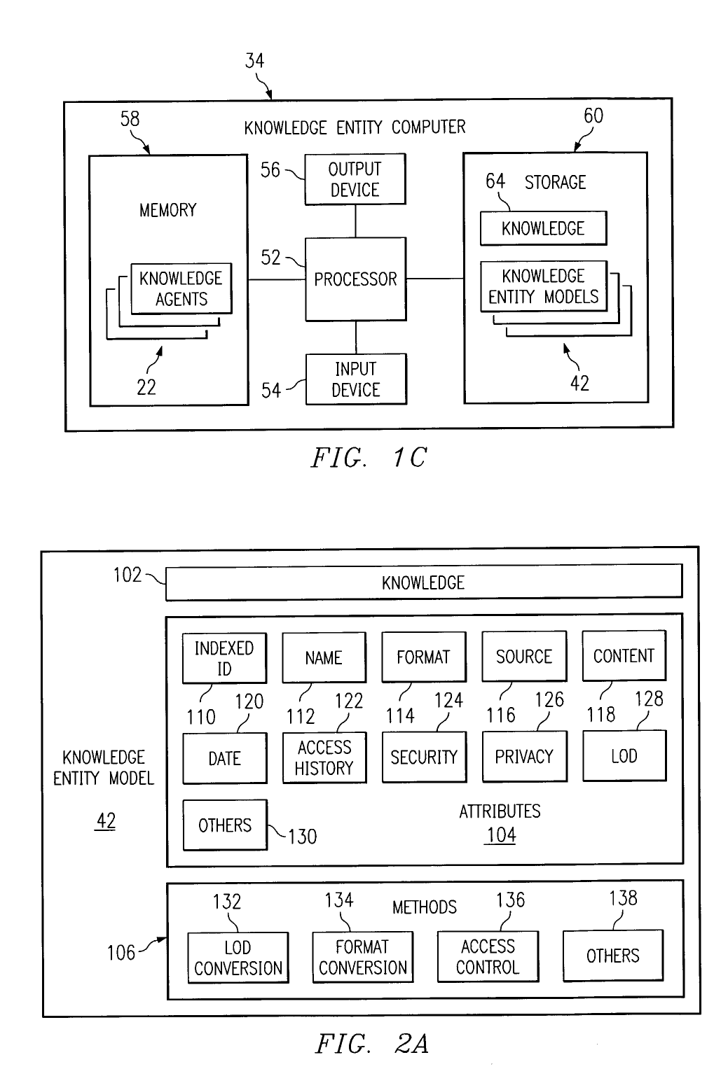

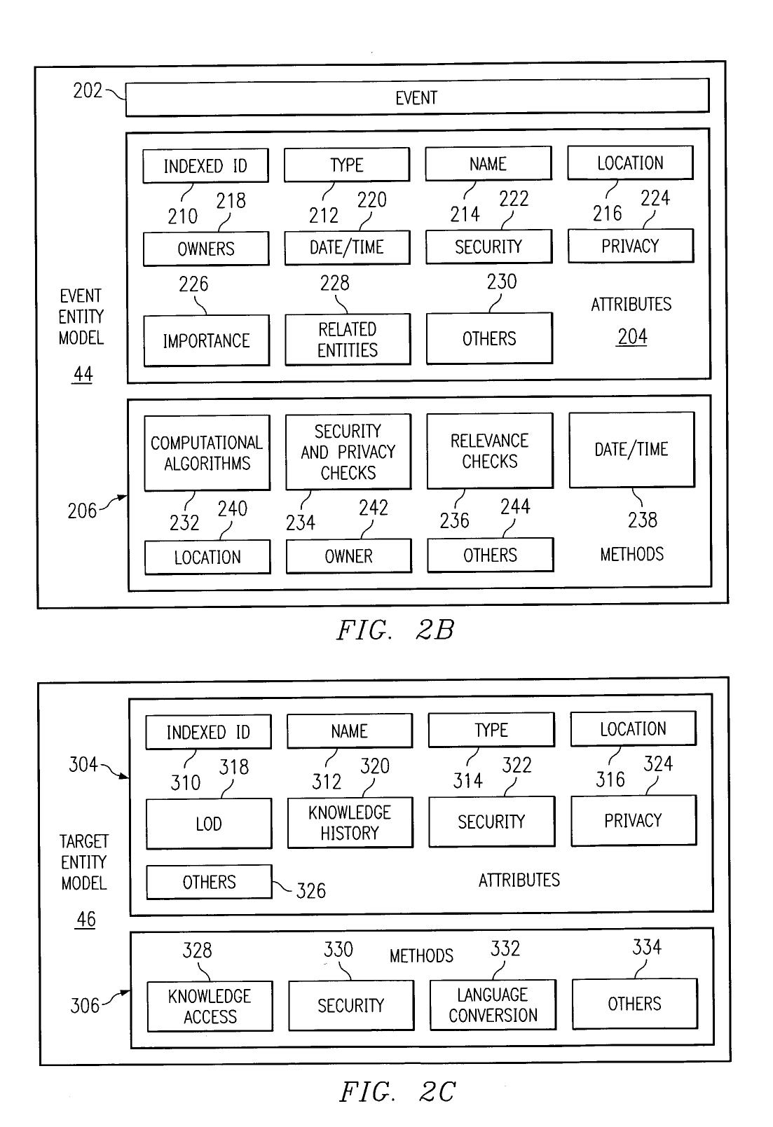

Knowledge entity 12 is a knowledge repository that may contain information desired by a target entity 16. Knowledge entity 12 may store static or dynamic information in various forms such as video, audio, text, etc. Examples of knowledge entities include libraries, databases, books, news stories, chapters of a book, etc. A knowledge entity may have associated with it a plurality of attributes that identify the particular knowledge entity 12. Those attributes are the same attributes as described below in conjunction with FIG. 2A in the description of a knowledge entity model.

Event entities 14 are events that cause a need for information to be acquired for knowledge entities 12. An example of an event is a meeting, the stock price exceeding a particular value, or the Dallas Cowboys winning the Super Bowl. Event entities 14 may be discrete or continuous. An example of a discrete event is a merger announcement, while an example of continuous event is the health needs of a person's children. Event entities may be described by a plurality of attributes such as those described below in conjunction with FIG. 2B.

Target entities 16 are the entities that use knowledge stored by knowledge entities 12. Target entity 16 may be a person, a group of people, a computer application, or other type of entity. Target entity 16 may have associated with it a plurality of attributes creating a profile. These attributes are described in greater detail below in conjunction with FIG. 2C.

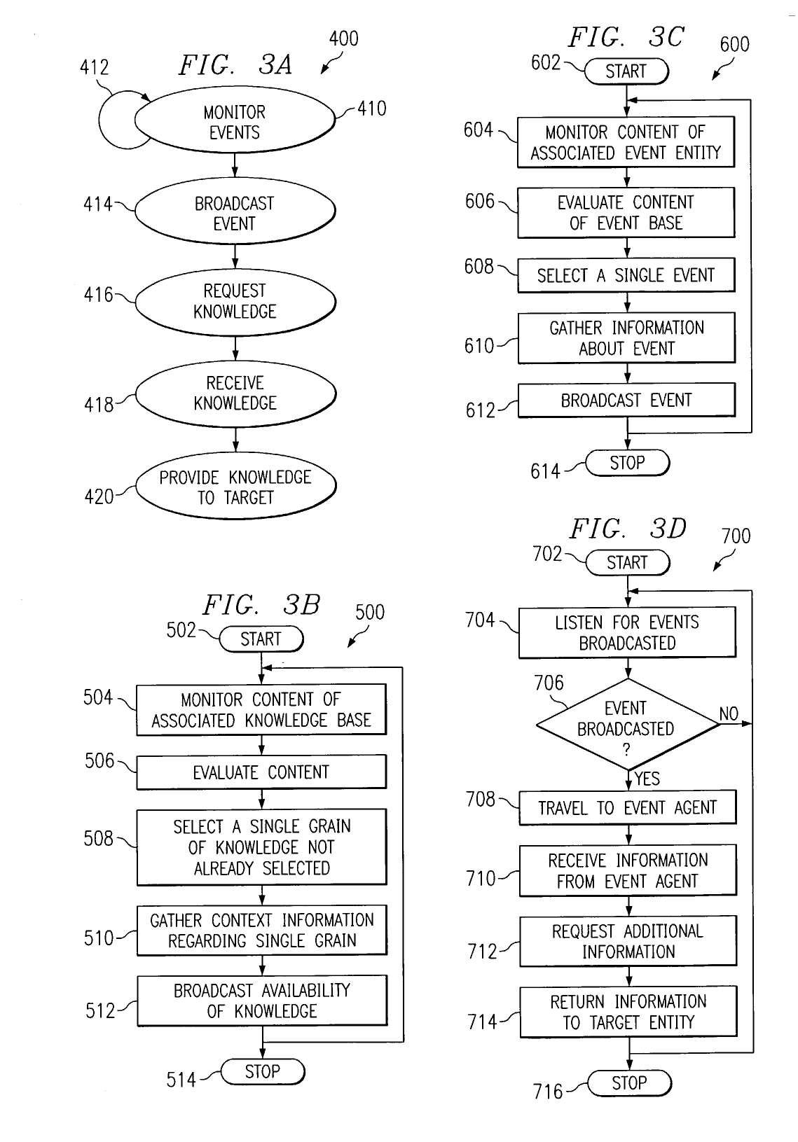

Agents 20 are generally small pieces of software (they can also be of larger size) that are designed to perform a particular task. In general, knowledge agents 22 and event agents 24 are stationary and are associated with a particular knowledge entity 12 and event entity 14, respectively; however, the agents may also be mobile. In contrast, target agents are more commonly mobile and travel from location to location in search of knowledge from knowledge entities 12. Agents 20 are described in greater detail below in conjunction with FIGS. 3A through 3D.

In general, however, knowledge agents 22 monitor the content of the knowledge base it is responsible for. Thus, knowledge agent 22 typically does not travel the network 18 and only searches within its own knowledge base, although knowledge agent 22 may travel. Knowledge agent 22 evaluates the content of the knowledge base, and selects a single grain of knowledge (e.g., a formula, document, image, news, contract), not already selected by other agents. Knowledge agent 22 also gathers information about the context of the knowledge, such as industry, category, format, level of detail, language, etc. Knowledge agent 22 broadcasts the availability of knowledge to other agents that have already shown an interest in this type of knowledge and/or responds directly to other agents that inquire about the availability of the specific type of knowledge (e.g., vehicle accidents in the northeast). Different knowledge agents 22 may collaborate with each other to convey a more complete message to target agents 26, i.e., similar agents are linked together by date and context, helping requesting agents locate other agents with related information.

An event agent 24 monitors the content of the event entity 14 it is responsible for. Thus event agent 24 does not typically travel the network and only searches within the specific event-base, although event agent 24 may travel. Event agent 24 evaluates the content of the event base and selects a single event (e.g., Kmart declared bankruptcy) not already selected by other agents. Event agent 24 also gathers information about the context of the event, such as date, location, industry, category, format, level of detail, etc. Event agent 24 broadcasts the availability of the event to other agents that have already shown an interest in this type of event, and/or responds directly to other agents that inquire about the availability of a specific type of event. Different event agents 24 may collaborate with one another to convey a more complete event scenario by the requesting target agents, i.e., similar agents are linked together by date and context, helping requesting agents locate other agents with related information. An example of an event agent is a Microsoft Outlook reminder. Another example is the monitoring of legal text to identify mergers between companies. According to one embodiment event agents are static and have a fixed IP address; however, event agents may be mobile in some embodiments. For events that are continuous rather than discrete, a target agent 26 may seek the event agent 24 as opposed to the event agent 24 broadcasting to the target agent 26 the occurrence of the event.

A target agent 26 operates in a similar fashion to a traditional intelligent agent, traveling networks and computer systems and targeting new information. Target agent 26 is autonomous but goal-oriented; thus it looks first for a specific type of information desired by its target entity owner 16. Each target agent 26 has a defined goal (e.g., company mergers and acquisitions). Target agent 26 is event-driven in response to the availability of a new event (via event agent 24) by searching for any/all relevant knowledge (via knowledge agents 22). In one embodiment, target agents do not automatically seek knowledge agents 22 unless this is specified as a goal (e.g., check the price of stock regardless of market activities). A plurality of target agents 26 may collaborate by searching for different pieces of information that collectively meet the user's needs.

FIG. 1B is an example implementation of active knowledge management system 10 of FIG. 1A. In this implementation, system 10 includes one or more knowledge entity computers 32, one or more event entity computers 34, and one or more target entity computers 36. In this embodiment, interfacing between knowledge entities 12, event entities 14, and target entities 16 is effected through use of computer systems having appropriate programs running therein. In this example implementation, knowledge entities 12, event entities 14, and target entities 16 are illustrated as residing on separate computer systems; however, such entities could also reside on the same computer system.

Any given knowledge entity computer 32 may comprise one or more knowledge agents 22 and one or more knowledge entity models 42. Knowledge entity models 42 each model a particular knowledge entity 12. For example, in the example where a knowledge entity is a book, a single knowledge entity model 42 may be stored in knowledge entity computer 32 that includes the knowledge of that book together with associated parameters. In another example, a book could be represented by a plurality of knowledge entity models 42, for example one knowledge entity model 42 for each chapter. Knowledge entity model 42 is described in greater detail below in conjunction with FIG. 2A. Knowledge entity model 42 may be represented in an object-oriented fashion and stored in memory on knowledge entity computer 32.

Knowledge agents 22 associated with a particular knowledge entity model 42 may be stored on the same knowledge entity computer 32 as the knowledge entity model 42, or may be stored on a different computer. Any knowledge entity model 42 may have associated with it one or more knowledge agents 22.

Event entity computer 34 is analogous to knowledge entity computer 32 and allows modeling of an event entity 14. Stored in event entity computer 34 are one or more event entity models 44 that model events together with associated attributes, as described in greater detail below. Event agents 24 may also be stored on the same event entity computer as the associated event entity model 44, or may be stored on other computers. Each event entity model 34 may be associated with one or more event agents 24.

Target entity computer 36 may be utilized to model a target entity 16, such as a person, through one or more target entity models 46.

Target entity model 46 represent a particular target entity 16 and contains a profile comprising a plurality of attributes, as described in greater detail below. A plurality of target agents 26 may also be stored on target entity computer 36, or on another computer. Each target entity model may have associated with it one or more target agents 26.

A network 50, such as the Internet, for example, may couple knowledge entity computers 32, event entity computers 34, and target entity computers 36 to each other. Target agents 26, which as described above, are often mobile, may travel through network 50 to obtain knowledge from knowledge entity models 42 as well as from event entity models 44.

FIG. 1C is a block diagram of knowledge entity computer 32. Event entity computer 34 and target entity computer 36 may take a form similar to that of knowledge entity computer 34 and are not described in detail herein. Knowledge entity computer 34 may comprise a processor 52 accessible by an input device 54 and an output device 56. Knowledge entity computer 34 may also include a memory area 58 and a storage area 60, both accessible by processor 52.

Processor 52 may take any suitable form including processors operable to execute the Windows and UNIX operating systems. Example processors are those available from Intel, Sun, and Advanced Micro Devices; however, others may also be used. Input device 54 may take any suitable form including a keyboard, a mouse, a stylus, verbal input, or other. Output device 56 may take any suitable form including a computer display or a printer. Memory 58 may take any suitable form including random access memory and read-only memory. Storage 60 is similar to memory 58 and may take any suitable form including random access memory and read-only memory. Stored in memory 58 in this example are knowledge agents 22. Although knowledge agents 22 are illustrated as being stored in memory 58 associated with a particular knowledge entity computer 34, knowledge agents may also be stored in other convenient locations associated with their particular associated knowledge entity model 42.

Storage 66 comprises a plurality of knowledge entity models 42, and the underlying knowledge 64. In the one example, the underlying model 64 corresponds to a database, and the knowledge entity models 42 correspond to particular portions of the database together with attributes defining knowledge entity model 42. Although knowledge 64 and knowledge entity models 42 are illustrated as being stored in storage 60, these components may also be stored in memory 58. Target entity computer 36 and event entity computer 34 may be formed similarly. In one embodiment, target agents 26 may reside in a memory in target entity computer 36, but may also travel to other locations to perform their operations, as described in greater detail below.

FIG. 2A is a block diagram of knowledge entity model 42. Knowledge entity model 42 may take the form of a data structure in an object-oriented program or other suitable form. In this example, knowledge entity model 42 comprises a knowledge portion 102, a plurality of attributes 104 and a plurality of methods 106.

Knowledge portion 102 comprises the underlying knowledge associated with the particular knowledge entity model. An example of the underlying knowledge 102 of knowledge entity model 42 is the stock price of a particular company along with all the associated information to uniquely define that stock price, including but not limited to it's index, ticker symbol, date, time, and any access control information.

The plurality of attributes 104 may include the following: an index ID 110, a name 112, a format 114, a source 116, a content 118, a date 120, an access history 122, a security attribute 124, a privacy attribute 126, a level of detail 128, and other attributes 130. Each of these attributes is described in greater detail below. Methods portion 106 may include a level of detail conversion, a format conversion 134, an access control 136, and other methods 140.

Index ID 110 provides a way of indexing the underlying knowledge 102. Example index IDs may include a uniform resource locator, a title, or other indexes. Name attribute 112 provides a name for the underlying information. In this example, name 112 may include the “EDS stock price.” Format attribute 114 stores the format that the underlying knowledge 102 is stored in. In this example, the format is text; however, other formats include video, voice, or other formats for storing information. The source attribute 116 identifies the source of the information of the underlying knowledge 102. For example, a company stock price may be readily ascertainable from a plurality of sources and some may be more timely inaccurate than others. Thus the source attribute 116 allows determination by user of the source of the information. The content attribute 118 includes the actual body of knowledge, such as the text of a news story or the clauses in a legal contract. However, the content is not limited to textual data, and may contain audio (voice, music, other sounds) or images (pictures, video etc.) or any other form of data. Attribute 118 contains only the data associated with knowledge portion 102.

Date attribute 120 stores the date of the knowledge such that a user may know whether the information is likely still current. Access history attribute 122 stores any prior access to this attribute, such as who may have accessed this information and when. Security attribute 124 stores security information that would prevent unauthorized users from obtaining information from knowledge entity model 42. Privacy attribute 126 stores additional information for access control where the knowledge portion 102, and specifically the knowledge content 108 may contain sensitive data. For example, in a hospital patient's medical records, the hospital admittance date may not be considered private, but HIV medical test results may be considered to be private. Although security attribute 124 controls access to the knowledge portion 102, privacy attribute 126 determines what portion of the data in content attribute 118 may be released and in what form. Level of detail attribute 128 stores an identification of the level of detail of the underlying knowledge 102. For example, the level of detail may be an overview or, conversely, very specific. In the present example of a stock price, the level of detail would be specific. Other attributes not specifically listed are also within the scope of the present invention.

As opposed to attributes 104, methods 106 store various functions of which knowledge entity model 42 is capable. Level of detail conversion 132 allows conversion of the stored information from one level of detail to another, such as from full text to a summary, a headline, or a single fact. Format conversion 134 allows conversion of the underlying information from one format to another. For example, a graphical image may be converted into a text image. Access control method 136, in this example, works with security attribute 124 and privacy attribute 126 to control access to knowledge entity model 42 to only authorized users. Other methods 140 not specifically described may also be used.

FIG. 2B is a block diagram illustrating event entity model 44. Event model entity model 44 may take the form of an object oriented data structure; however, it may also take other forms. In this embodiment, event entity model 44 comprises an event 202, a plurality of attributes 204 associated with the event, and a plurality of methods 206 associated with the event.

Event 202 is the underlying event, such as change in stock price, the outbreak of war, or the Dallas Cowboys winning the Super Bowl. Attributes 204 comprise a plurality of parameters used to identify the event and make event 202 more readily useable by target agents 26. Methods 206 comprise a plurality of methods usable by event entity model 44 to make the underlying event information 202 available to target agents 26.

Attributes 204 include an index identification 210, a type 212, a name 214, a location 216, an owner 218, the date and time 220, a security attribute 222, a privacy attribute 224, an importance attribute 226, related entities 228, and other attributes 230. Index identification 210 for event entity model 44 may take the same form as index ID 110 of knowledge entity model, including a uniform resource locator, and it is used to provide an index to the underlying event 202. Type 212 stores the type of information, such as “sports”, “business”, and “news.” The name attribute 214 stores a name associated with an event. For example, “change in EDS stock price”. Location 216 stores the location of a particular event. The location attribute may provide an indication of the importance to a particular target entity. For example if the event were a change in EDS stock price, the event would be of more importance to a target residing in the United States than a target entity residing outside the United States. Owner attribute 218 stores an indication of the ownership of the event, which may be the source of the event or the reporting agency. For example, in a news story discussing a bankruptcy, the owner of the event may be the bankrupt company but the owner of the news story may be a reporter or a news wire agency. Date and time attribute 220 stores the date and time of the occurrence of event 202. Security attribute 222 and privacy attribute 224 are similar to those corresponding attributes described above in conjunction with knowledge entity model 42. Importance attribute 226 is an indication of the importance of the event 202 to a particular target entity 16. Thus, importance attribute 226 is, in this example, not necessarily a static number but may comprise a formula that would result in a different importance level based upon the target entity receiving or requesting the event 202. Related entities attribute 228 stores a listing of event entities, knowledge entities, and target entities that may be related to event 202 such that a target agent could examine those entities in response to event 202. Other attributes 230 may also be provided.

Methods 202 comprise computational algorithms 232, security and privacy checks 234, relevance checks 236, date and time 238, location 240, owner 242, and others 244. Computational algorithms 232 may be provided for any analysis or computation that may be required to properly describe an event; for example, a news story may reference an event having taken place “two weeks ago”; in such a case an algorithm is required to compute the actual date of the event by subtracting 14 days from the date of the news story. Therefore, computational algorithms 232 may contain a large number of algorithms that may be generic in nature (such as Date computations) or domain-specific (such as interpreting and mapping diagnostic error codes in a machine-tool maintenance manual. Security and privacy checks 234 contains the necessary functionality to grant access only to appropriate agents to the information in event entity model 44. Relevance checks 236 performs functions associated with determining whether the event is relevant and in scope. For example, for a securities insider trading application, the first reference to a company's bankruptcy is highly relevant but subsequent references are irrelevant. Relevance checks 236 typically consist of algorithms and heuristics that check the event for relevance and determine whether the event should be reported or not. Therefore, the primary function of relevance checks 236 is to reduce the number of false-positives in event reporting. Date/time method 238 operates to generate the date/time of a particular event and store that information in date/time attribute 230. Location 240 is a method that allows determination of the location stored in location attribute 216 associated with a particular event. For example, an EDS stock price change may have a location of the United States. In addition, the location 240 may also determine the position within a content where an event is reported, such as paragraph 4, sentence 3, word 5. Owner 242 method is used to derive the owner of an event either directly from the event portion 202 or any other entity that may contain such information. The output of owner 242 is stored in owner 218 for future reference. Other methods 244 may be provided as needed.

FIG. 2C is a block diagram of target entity model 46. Target entity model represents a particular target entity such as a person. In this example, target entity model may take the form of data structure in an object oriented computer program. Target entity model comprises a plurality of attributes 304 and a plurality of methods 306. In general, attributes 304 describe the associated target such that information that is relevant to the target may identified, and methods 306 provide functionality for interfacing with interfacing with target entity model 46. Attributes 304 comprise an indexed identification 310, a name, 312, a type 314, a location 316, a level of detail 318, a knowledge listing 320, a security indicator 322, a privacy indicator 324, and other attributes 326. The individual attributes 304 are similar to those described above in conjunction with event entity model 44 and knowledge entity model 42.

Methods 306 may include knowledge access method 328, security method 330, language conversion method 332 and other methods 334. Knowledge access method 328 provides functionality for determining the type of knowledge that the target entity may find useful. For example, a knowledge access 328 that services a stock broker may determine that knowledge such as stock price, future prices, and merger acquisition information are of particular interest to the target entity (e.g., the stock broker in this example). Security method 330 provides functionality for capturing the security information associated with the target entity; this information may consist of user ID, password, or access levels. This information will be used by the target agent to access and retrieve secure information as permitted by the security protocols. Language conversion program functionality 332 provides functionality for resolving multi-lingual issues. For example, the target entity may be a person who only speaks German. In this case, the language conversion 332 translates all information to/from German so that this entity could communicate with other entities (Knowledge and Event) and to present the retrieved information in a language understood by the target. Other methods 334 may also be provided within target entity model 46.

The operation of active knowledge management system is described below in conjunction with FIGS. 3A through 3D. FIG. 3A is a state diagram of a method 400 for active knowledge management. FIG. 3A provides an overview of activities performed by knowledge agents 22, event agents 24, and target agents 26 in obtaining information from knowledge entities 12 and event entities 14 for provision to target entities 16. Additional details of actions associated with each of knowledge agents 22, event agents 24, and target agents 26 are described in greater detail below in conjunction with FIGS. 3B through 3D, respectively.

At an initial state 410, event agent 24 monitors for an associated event. Monitoring continues as indicated by reference numeral 412 until the event occurs. Once the event occurs, event agent 24 broadcasts the event, as indicated by reference numeral 414. In response, a target agent 26 receives the broadcasted notification of the event occurring and requests knowledge associated with that event from a knowledge entity 12. Target agent 26 knows from which knowledge entity 12 to request information because knowledge agents 24 have previously broadcast the availability of particular knowledge, which was received by target agent 26. At step 418, target agent 26 receives knowledge 102 and takes that knowledge back to the associated target entity computer 36. The nature of the information that is transmitted to the target entity is actually determined by several factors such as, 1) Language, which determines that output language, 2) Level-of-Detail (LOD), which determines how much of the information is transmitted (e.g., all, summary, headline, a single number, and history, and 3) Security & Privacy, which determines what aspects of the information, if any, is permitted to be transmitted. At step 420 the received knowledge is provided to target entity computer 36 by target agent 26.

In this manner, relevant information may be provided to people at the relevant time with the correct level of detail. Doing so provides more efficient knowledge management, allowing the underlying target entity 12 to spend time analyzing only important information rather than spending time obtaining the important information. The teachings of the invention recognize that performing the following steps associated with knowledge management automatically provides a valuable system: determining the awareness of the need for knowledge, determining the awareness of the existence of the desired knowledge, access to the knowledge, development of a search paradigm, selecting the appropriate knowledge from the search result, formatting the result relative knowledge, and reading through and extracting what is needed. By automating these steps, a more useful management tool is provided. Additional details of example steps performed by knowledge agents 22, event agents 24 and target agents 26 are described in greater detail below.

FIG. 3B is a flowchart show example steps associated with knowledge agent 22 during acquisition of knowledge. In general, knowledge agent 22 announces availability of knowledge to the outside world, particularly target agents 26. In one embodiment knowledge agents 22 are stationary, autonomous, single task, real time, collaborative and based on a single platform. Knowledge agent 22 does not need to be personalized, but may be customized in response to the design of the knowledge base and the contextual information that represents the knowledge. Personal customization may be accomplished via means such as XML and rules. Depending on the nature of the knowledge and its application, the knowledge agent may be secured at different levels. First, the extent of the broadcast may be controlled to limit the exposure of knowledge to the pre-determined agents only. As a second alternative, security is limited to registered agents only. Or, security is controlled by user ID password of the final user as conveyed by the requesting agent. Finally, the knowledge content of the agent may be encrypted. A knowledge agent may be created in response to the introduction of new knowledge. The new agent would freely roam the knowledge base until it locates a new event and the new agent subsequently replaces this agent.

A method 500 of acquiring knowledge begins at step 502. At a step 504 a knowledge agent 22 monitors the content of the associated knowledge base, and at step 506 the content of the knowledge base is evaluated. At step 508 a single grain of knowledge not already selected is selected by the knowledge agent 22. At step 510 context information regarding the single grain of information is also collected, and this information is stored in the form of attributes, such as those described above in conjunction with FIG. 2A. Once knowledge entity model 42 is then formed based upon the selected single grain of knowledge and the associated attributes and methods, knowledge agent 22 broadcasts the availability of knowledge as well as associated knowledge agents. In another example, rather than broadcasting this information, this information is transmitted to specific target agents 26 in response to requests from the target agents to send information of a particular type. This process continues for all knowledge events. The limiting factors are the relevance 236, any algorithms or heuristics 232 and 328, and possibly others, 138, 244, and 334 that may define rules for the quantity of retrieved. The method concludes at step 514.

FIG. 3C is a flowchart illustrating sample steps associated with event agent 24 in performing active knowledge management according to the teachings of the invention. In general, event agent 24 is a broadcast agent that announces the availability of an event to the outside world, particularly to target agents 26. Event agent is characterized, in one embodiment, as being stationary, autonomous, single-tasked, real time, collaborative and having a single platform, although in other embodiments event agent 24 may possess different characteristics. Event agent 24 is personalized, in this embodiment, only in response to the design of the event base, and the contextual information that represents the event. Personalization may be accomplished via means such as XML. Depending on the nature of the event, event agent 24 may be secured at different levels. First, the extent of the broadcast may be controlled to limit exposure of knowledge to the predetermined agents only. As a second alternative, security is limited to registered agents only. Or, security is controlled by user ID/password of the final user as conveyed by the requesting agent. Finally, the event content of the agent may be encrypted. Event agent 24 is created in response to the introduction of a new event. A new event agent does not typically roam. It is typically a static entity that may persist for a long time (or as permitted by memory and disk space).

A method 600 of acquiring knowledge begins at step 602. At a step 604 event agent 24 monitors the content of associated event entities 14, and evaluates the content of the event base at step 606. At step 608 event agent 24 selects a single event. For example “Kmart declared bankruptcy.” At step 610 information is gathered regarding this event and the event is broadcast at step 612. In addition to broadcasting the event at step 612, additional information including associated events may be broadcast in the form of attributes illustrated in FIG. 2B. The method concludes at step 614. In one embodiment, nothing happens to the event agent after the event is broadcast. It remains stationary until a target agent either responds to the broadcast or comes across it while roaming. Upon an action by a target agent, the event agency simply releases appropriate information to the target agent and then waits for other target agents to approach it. The method concludes at step 614.

FIG. 3D is a flowchart illustrating example steps associated with target agents 26 according to the teachings of the invention. In general, a target agent 26 is a search agent that searches information within a network seeking new information such as events and knowledge. A target agent is characterized, in one embodiment, as being mobile, autonomous, single-task, goal oriented, real time, event-driven, collaborative and multi-platform; however, target agents may possess different characteristics in other embodiments. Target agents 26 are highly personalized. They represent the needs of their owner (target entity 16), including, in some embodiments, the owners authentication credentials, desired level of detail, language, depth of information, etc. Personalization is achieved via means such as XML. In other words, target agent 24 is personalized via attributes 310 through 326 and any functionality defined in methods 328 through 334. According to one embodiment, each target agent 26 carries the authentication credentials of its owner, target entity 16. The informational content of target agent 26 can only be released to its owner, target entity 16 via an access protocol and encryption. This target agent is created in response to the needs of a target entity 16. Such needs may be discrete, such as where one or more agents are released to search for specific information, or continuous, such as where one or more agents autonomously search their information network for any “interesting” event.

A method 700 of acquiring knowledge begins at step 702. At a step 704 target agent 26 listens for events broadcasted related to a specific type of information desired by the associated target entity 16. At a step 706 target agent 26 hears an event broadcast or knowledge broadcast. In response, target agent 26 travels to the event agent, and at step 710 receives information from the event agent 26 (or knowledge agent 22). At step 712 additional information may be requested and at step 714 the information is returned to the target entity. The method concludes at step 716.

Although the present invention has been described in detail, it should be understood that various changes, substitutions, and alterations can be made hereto without departing from the spirit and scope of the invention as defined by the appended claims.

What is claimed is:

1. A network of computers for active knowledge management comprising:
a plurality of event agents operable to monitor for an event, capture the attributes of the event, and announce the event;
a plurality of knowledge agents operable to examine a knowledge base, broadcast characteristics of the knowledge base, and interface with the knowledge base to extract knowledge in response to a request from a target agent; and
a plurality of target agents operable to listen for broadcasted events and in response, travel to one of the knowledge agents, request knowledge related to the event, receive the requested knowledge, and deliver the received knowledge to a computer associated with the target agent.

2. The network of claim 1, wherein the target agent is further operable to exchange information with the knowledge agent.

3. The network of claim 1, and further comprising a plurality of knowledge entity models stored on one of the computers each describing attributes of an associated piece of knowledge.

4. The network of claim 3, and further comprising a plurality of target entity models each stored on one of the computers each describing attributes of an associated target entity.

5. The network of claim 4, and further comprising a plurality of event entity models each stored on one of the computers each describing attributes of an associated event.

6. The network of claim 3, wherein the knowledge entity model additionally comprises methods associated with the piece of knowledge.

7. The network of claim 4, wherein the target entity model additionally comprises methods associated with the associated target entity.

8. The network of claim 5, wherein the knowledge entity model additionally comprises methods associated with the associated event.

9. A computerized method for active knowledge management comprising:
automatically monitoring for an event and, in response to the event, capturing attributes of the event and announcing the event;
automatically examining a knowledge base and broadcasting characteristics of the knowledge base;
listening for the broadcasted event, and in response to hearing the broadcasted event, requesting knowledge related to the event;
interfacing with a knowledge base storing the requested knowledge to extract the requested knowledge; and
receiving the requested knowledge and delivering the received knowledge to a computer associated with an entity desiring the received knowledge.

10. The method of claim 9 wherein automatically monitoring for an event comprises automatically monitoring for an event by an event agent operable to capture the attributes of the event, and announce the event.

11. The method of claim 9, wherein listening for the broadcasted event comprising listening by target agent operable to travel to one of the knowledge agents, request knowledge related to the event, receive the requested knowledge, and deliver the received knowledge to a computer associated with the target agent.

12. The method of claim 9, wherein interfacing with a knowledge base storing the requested knowledge to extract the requested knowledge comprises interfacing by a knowledge agent operable to examine a knowledge base and broadcast characteristics of the knowledge base.

13. The method of claim 9, and further comprising storing the knowledge in a knowledge entity model.

14. The method of claim 9, and further comprising storing the event in an event entity model.

15. A computer system comprising for active knowledge management comprising:
a plurality of event entity computers storing a plurality of event agents operable to monitor for an event, capture the attributes of the event, and announce the event;
a plurality of knowledge entity computers storing a plurality of knowledge agents operable to examine a knowledge base, broadcast characteristics of the knowledge base, and interface with the knowledge base to extract knowledge in response to a request from a target agent; and
a plurality of target entity computers storing a plurality of target agents operable to listen for broadcasted events and in response, travel to one of the knowledge agents, request knowledge related to the event, receive the requested knowledge, and deliver the received knowledge to a computer associated with the target agent.

16. The computer system of claim 15, wherein the target agent is further operable to exchange information with the knowledge agent.

17. The computer system of claim 15, and further comprising a plurality of knowledge entity models stored on one of the computers each describing attributes of an associated piece of knowledge.

18. The computer system of claim 17, and further comprising a plurality of target entity models stored on the target entity computers, each describing attributes of an associated target entity.

19. The computer system of claim 18, and further comprising a plurality of event entity models stored on the event entity computers, each describing attributes of an associated event.

20. The network of claim 17, wherein the knowledge entity model additionally comprises methods associated with the piece of knowledge.

21. The network of claim 18, wherein the target entity model additionally comprises methods associated with the associated target entity.

22. The network of claim 19, wherein the knowledge entity model additionally comprises methods associated with the associated event.
